(19) United States
(12) Patent Application Publication
(10) Pub. No.: US 2026/0322101 A1
(43) Pub. Date: Oct. 15, 2026

(54) GROUND STRUCTURE OF POWER CABLE CONNECTION BOX

(71) Applicant: TAI HAN ELECTRIC WIRE CO., LTD., Gyeonggi-do (KR)

(72) Inventors: Dong Suk HONG, Chungcheongnam-do (KR); Jae Hyuk SONG, Chungcheongnam-do (KR); Seong Jung KIM, Chungcheongnam-do (KR)

(73) Assignee: TAI HAN ELECTRIC WIRE CO., LTD., Gyeonggi-do (KR)

(21) Appl. No.: 19/484,288

(22) PCT Filed: May 9, 2024
(86) PCT No.: PCT/KR2024/006272

§ 371 Date: Nov. 13, 2025

(30) Foreign Application Priority Data
May 17, 2023 (KR) 10-2023-0063835

(51) Int. Cl. H02G 15/103; H02G 15/007; H02G 15/013

(52) U.S. Cl. CPC H02G 15/103; H02G 15/007; H02G 15/013

(57) ABSTRACT

Disclosed is an anti-corrosion structure for preventing corrosion between a protection pipe of a connection box and a cable. A ground structure of a power cable connection box connects a pair of power cables and may include a pair of protection pipes that protect the inside of the connection area. The ground structure may include: a flange included in one end of the protection pipe and fastened to a connection component of the connection box; a packing flange formed between the flange; a fastening flange fastened to the other end of the protection pipe and a support flange including a cylindrical pipe for packing; at least one bolt tab formed inside the packing flange; and a ground wire having one end fastened to a metal sheath of the pair of power cables, and another end connected to a bolt and fastened to the bolt tab.

### TECHNICAL FIELD

The present invention relates to a ground structure of a power cable connection box, and more particularly, to a ground structure of a power cable connection box, which is an improved ground structure as well as an improved anti-corrosion structure through connection between a protection pipe and an auxiliary fitting of the connection box.

### BACKGROUND ART

In general, a power cable is used to supply electric power to a desired location through underground, aboveground, or undersea by using a conductor that supplies electric power.

The above-described power cable is connected at intervals of several hundred meters or several kilometers by a joint box, and an end of the power cable is connected to an overhead line or a circuit breaker by a termination connection box.

Each of the joint box and the termination connection box is connected to connection portions of the power cable to compensate for dielectric breakdown of all sorts of insulation components and has a structure to which a protection pipe is inserted and fastened to protect an exposed portion of the power cable.

Since corrosion of the power cable may occur by moisture or foreign substances introduced into the connection box, an anti-corrosion layer for preventing corrosion is designed to have a size between an inner diameter of the protection pipe and an outer diameter of the power cable and coupled between the protection pipe and the power cable.

FIG. 1 is a view illustrating a structure of a ground part and an anti-corrosion part of a connection unit of a conventional power cable.

All sorts of connection materials are coupled to an end of a power cable 11, which is cut for connection, and a protection pipe 12 is disposed and fastened to an aluminum sheath of the power cable 11 to protect an exposed portion of the power cable 11.

Rubber putties 13a, 13b, and 13c are inserted to a connection portion between the protection pipe 12 and the power cable 11, a connection portion between a compound part 15 and the protection pipe 12, and a connection portion between the compound part 15 and the power cable 11, respectively, and an anti-corrosion process is performed by a process of processing outermost portions by using a heat shrinkable tube 17.

Aground wire 14 is inserted between the protection pipe 12 and the power cable 11 for electrical ground connection in such a manner that the ground wire 14 is bound to the power cable 11 by a band 16.

The above-described conventional anti-corrosion process uses a rubber putty that is a material made of rubber to fill a gap such as a seam or a crack in a spaced space occurring between a fitting and a power cable for an anti-corrosion layer, which causes a limitation of having a complicated structure and requiring numerous components and a long working process time.

Also, although the conventional ground structure is configured such that the protection pipe 12 and the aluminum sheath of the power cable 11 are connected by the ground wire 14, and the ground wire 14 is fixed to each of the protection pipe 12 and the power cable 11 by the band 16 and then reinforced by the compound 15, the ground wire connection structure is inconvenient in that the band is required to be fixed while the ground wire 14 is in a non-fixed state of being connected to two objects, and is not desirable in that the ground wire connection structure requires reinforcement by the compound 15.

### RELATED ART DOCUMENTS

### Patent Documents

(Patent Document 1) Korean Patent Publication No. 10-2019-0114091.

### DISCLOSURE OF THE INVENTION

### Technical Problem

The present invention provides a ground structure of a power cable connection box, which removes a spaced space between a protection pipe and a power cable to prevent corrosion and improves a ground connection structure between the protection pipe and the power cable.

Technical objects to be solved by the present invention are not limited to the aforementioned technical objects and unmentioned technical objects will be clearly understood by those skilled in the art to which the present invention belongs.

### Technical Solution

An embodiment of the present invention provide a ground structure of a power cable connection box, which connects a pair of power cables to each other and includes a pair of protection pipes that protect the inside of a connection area and are connected to the pair of power cables, respectively, the ground structure including: a flange integrated with one end of the protection pipe so as to be fastened to a connection component of the connection box; a packing flange disposed between the flange and the other end of the protection pipe to face downwardly from an inner surface of the protection pipe; a support flange including a fastening flange fastened to the other end of the protection pipe and a packing cylindrical pipe; at least one bolt tab disposed inside the packing flange; and a ground wire having one end, which is fastened to a metal sheath of each of the pair of power cables by a wire and soldered, and the other end, which is connected to a bolt and fastened to the bolt tab.

In an embodiment, the ground structure may further include a rubber packing supporter disposed in a space defined by the packing flange and the fastening flange to implement an anti-corrosion structure through fastening between the packing flange and the fastening flange.

In an embodiment, the fastening flange may have an outer diameter less than an inner diameter of the protection pipe, and the rubber packing supporter may have an outer diameter less than the inner diameter of the protection pipe.

In an embodiment, the protection pipe, the support flange, and the rubber packing supporter may be coupled to perform a cleat function that holds the power cable to prevent the power cable from being pushed.

In an embodiment, one end of the ground wire may be further fixed to the metal sheath of the power cable by a band.

In an embodiment of the present invention, a ground structure of a power cable connection box, which connects a pair of power cables to each other and includes a pair of protection pipes that protect the inside of a connection area and are connected to the pair of power cables, respectively, includes: a flange integrated with one end of the protection pipe so as to be fastened to a connection component of the connection box; a packing flange disposed between the flange and the other end of the protection pipe to face downwardly from the inner surface; a support flange including a fastening flange fastened to the other end of the protection pipe and a packing cylindrical pipe; at least one bolt tab disposed inside the packing flange; and a ground wire having one end, which is fastened to a metal sheath of each of the pair of power cables, and the other end, which is connected to a bolt and fastened to the bolt tab.

In an embodiment, one end of the ground wire may be wound around the metal sheath of the power cable by a wire and connected thereto through soldering at a predetermined position.

In an embodiment, one end of the ground wire may be fixed and connected to the metal sheath of the power cable by a band.

### Advantageous Effects

The present invention may propose the anti-corrosion structure of the connection box, which removes the spaced space between the protection pipe and the power cable to prevent corrosion.

Also, the working process efficiency may be secured by simplifying the process of forming the anti-corrosion layer through the metal fitting fastening and reducing the number of components.

Also, the cleat function that holds the cable to prevent the cable from being pushed may be performed by the coupling between the protection pipe, the support flange, and the rubber packing supporter disposed therebetween.

However, the effects of the present invention are not limited to the aforementioned benefits and may be variously extended without departing from the spirit and scope of the invention.

### BRIEF DESCRIPTION OF THE DRAWINGS

FIG. 1 is a view illustrating a structure of a ground part and an anti-corrosion part of a connection unit of a conventional power cable.

FIG. 2 is a view illustrating an anti-corrosion process state and a ground structure before fastening in an anti-corrosion structure of a power cable connection box according to an embodiment of the present invention.

FIG. 3 is a view illustrating an anti-corrosion process state and a ground structure after fastening in the anti-corrosion structure of the power cable connection box according to an embodiment of the present invention.

FIG. 4 is a view illustrating an anti-corrosion part of the anti-corrosion structure of the power cable connection box according to an embodiment of the present invention.

FIG. 5 is a view illustrating the ground structure of the power cable connection box according to an embodiment of the present invention.

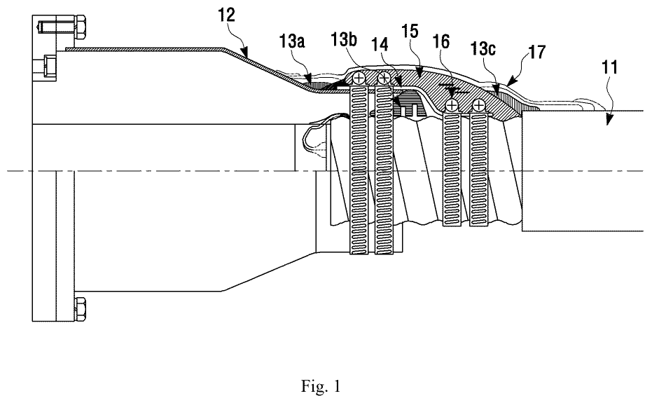

### MODE FOR CARRYING OUT THE INVENTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. The invention may, however, be embodied in many different forms and should not be construed as being limited to the embodiments set forth herein. Therefore, it will be understood that the embodiments disclosed in this specification includes some variations without limitations to the shapes as illustrated in the figures. Also, the position or the arrangement of each component in the embodiment may be varied without departing form the spirit or scope of the invention. The preferred embodiments should be considered in descriptive sense only and not for purposes of limitation. Therefore, the scope of the invention is defined not by the detailed description of the invention but by the appended claims, and all differences within the scope will be construed as being included in the present invention. In the drawings, like reference numerals refer to like elements throughout.

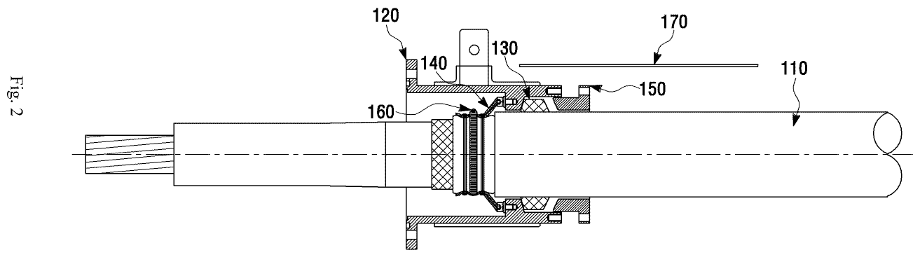

FIG. 2 is a view illustrating an anti-corrosion process state and a ground structure before fastening in an anti-corrosion structure of a power cable connection box according to an embodiment of the present invention.

As illustrated in FIG. 2, in the connection box according to an embodiment of the present invention, all sorts of connection materials (not shown) are coupled for insulation reinforcement to a front end (or an intermediate portion at which materials are connected to each other) of a power cable 110 that is cut for connection.

Here, the connection box includes an joint box and a terminal connection box. In the case of the joint box, various connection materials for connecting a pair of power cables 110 may be connected, and in the case of the termination connection box, various connection materials may be connected to the front end of the power cable 110.

Although only one power cable 110 and the connection box are illustrated in the drawing, the embodiment of the present invention is not limited thereto. For example, the connection box may be the joint box or the termination connection box.

A protection pipe 120 may be disposed and fastened to an exposed portion of the power cable 110 to protect the exposed portion of the power cable 110 and a portion of a connection component.

The protection pipe 120 may have one side fastened to an insulating material (not shown) of the connection box and the other end connected to a predetermined position of the power cable 110 through a process of forming an anti-corrosion part for preventing moisture or foreign substances from being introduced into a predetermined spaced space.

The forming of the anti-corrosion part may be performed by coupling between the protection pipe 120 and a support flange 150, and arranging a rubber packing supporter 130 in a space defined by the protection pipe 120 and the support flange 150 in a close contact manner and protecting an outer side thereof by applying heat to a heat shrinkable tube 170.

Electrical ground wire connection between the power cable 110 and the protection pipe 120 has a structure in which the ground wire 140 has one side bolted to the protection pipe 120 and the other side connected to an aluminum sheath of the power cable 110 through a band 160.

The above-described ground wire connection structure may improve a conventional ground wire connection structure to resultantly improve the anti-corrosion structure of a conventional power cable connection box.

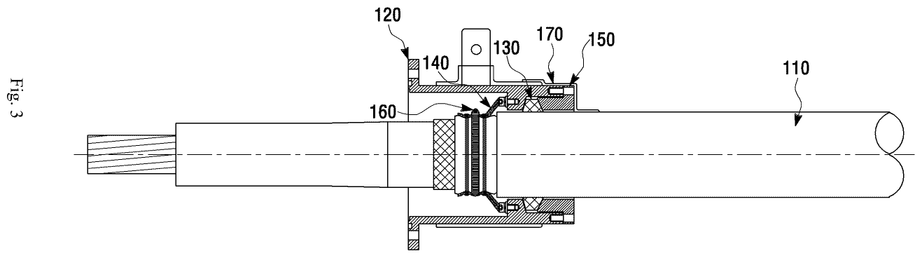

FIG. 3 is a view illustrating an anti-corrosion process state and a ground structure after fastening in the anti-corrosion structure of the power cable connection box according to an embodiment of the present invention.

FIG. 2 illustrates the anti-corrosion process state before fastening in the anti-corrosion structure of the connection box, and FIG. 3 illustrates the anti-corrosion process state after fastening in the anti-corrosion structure of the connection box.

Referring to FIG. 3, prevention of corrosion inside the connection box of the power cable 110 may be primarily secured in such a manner that one side of the protection pipe 120 is fastened to a reinforcing insulation member of the connection box in a state in which the protection pipe 120 is set to a predetermined position, the other side is fitted with the support flange 150 in a state in which the rubber packing supporter 130 is fitted to the other side, and, while the support flange 150 and the other side of the protection pipe 120 are assembled, the rubber packing supporter 130 disposed therebetween is compressed.

The prevention of corrosion may be secondarily secured by a heat shrinkable tube 170.

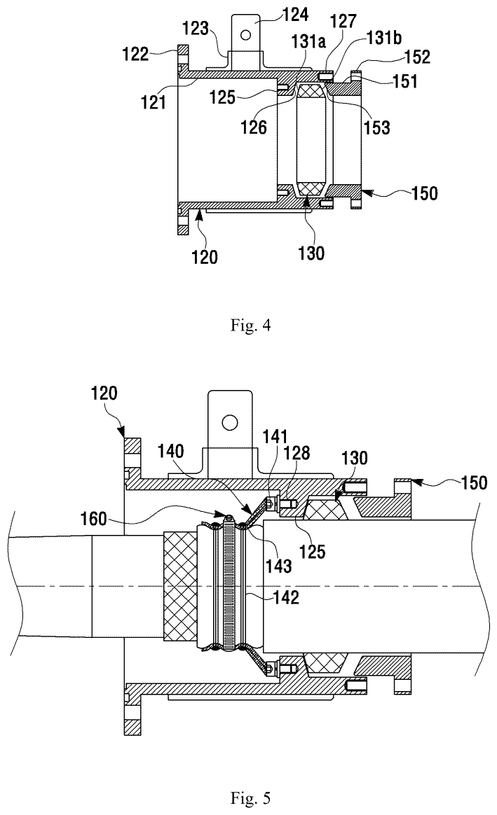

FIG. 4 is a view illustrating an anti-corrosion part of the anti-corrosion structure of the power cable connection box according to an embodiment of the present invention.

The anti-corrosion part of the connection box will be described in more detail with reference to FIG. 4.

As a structure of the anti-corrosion part of the connection box is improved, a ground connection structure of the connection box may be simultaneously improved.

In other words, as the ground connection structure of the connection box is improved, the anti-corrosion structure of the connection box may be improved together.

The connection box according to the present invention is designed so that the structure of the anti-corrosion part may be implemented by the protection pipe 120, the rubber packing supporter 130, and the support flange 150.

In general, the protection pipe 120 has a structure of a cylindrical pipe 121. The protection pipe 120 may have one end formed such that a flange 122 for connection with an insulation member is integrated or coupled with the cylindrical pipe 121 and the other end on which a bolt tab 127 for fastening of the support flange 150 is formed.

A packing flange 125 that is directed inward for a compressive contact of the rubber packing supporter 130 may be formed at an intermediate portion of the cylindrical pipe 121, and the packing flange 125 may have one surface on which a bolt tab for connection of the ground wire 140 with the power cable 110 is formed and on the other surface on which a first inclined surface 126 is formed for a close contact by pressure applied from the rubber packing supporter 130.

A ground terminal 124 and a protection layer 123 may be further formed on an outer circumference of the protection pipe 120.

The support flange 150 may be formed by integration or coupling between a packing cylindrical pipe 151 and a fastening flange 152, and a second inclined surface 153 that is inclined in a direction opposite to the first inclined surface 126 may be formed on one surface of the packing cylindrical pipe 151.

A plurality of bolt holes may be formed in the fastening flange 152, and the bolt tabs 127 of the protection pipe 120 may be fastened to the corresponding bolt holes by bolts or the like.

Since an outer diameter of the packing cylindrical pipe 151 is less than an inner diameter of the protection pipe 120, the packing cylindrical pipe 151 may be inserted into the protection pipe 120.

The rubber packing supporter 130 may have a donut shape having an inner diameter and have a trapezoidal cross-sectional shape having third and fourth inclined surfaces 131a and 131b at both sides.

The rubber packing supporter 130 may be designed to have an inner diameter having a size insertable into the power cable 110 and an outer diameter having a size insertable into the protection pipe 120.

Fastening between the protection pipe 120 and the support flange 150 may allow the rubber packing supporter 130 disposed therebetween to be elastically compressed and completely sealed.

As the protection pipe 120 is fastened to the support flange 150, the first inclined surface 126 of the protection pipe 120 may be brought into contact with the third inclined surface 131a of the rubber packing supporter 130, and the second inclined surface 153 of the support flange 150 may be brought into contact with the fourth inclined surface 131b of the rubber packing supporter 130, thereby applying pressure from both sides and forming a sealing structure that prevents external moisture from being introduced.

Also, as the protection pipe 120 is fastened to the support flange 150, the first inclined surface 126 of the protection pipe 120 may be brought into contact with the third inclined surface 131a of the rubber packing supporter 130, and the second inclined surface 153 of the support flange 150 may be brought into contact with the fourth inclined surface 131b of the rubber packing supporter 130, thereby performing a cleat function that holds the power cable 110 to prevent the power cable 110 from being pushed while applying pressure from both sides.

FIG. 5 is a view illustrating the ground structure of the power cable connection box according to an embodiment of the present invention.

Referring to FIG. 5, the anti-corrosion in FIG. 4 may be improved to resultantly improve the ground wire connection structure of the connection box.

FIG. 5 is an enlarged view of FIG. 2, in which fastening between the protection pipe 120, the rubber packing supporter 130, and the support flange 150 may improve the anti-corrosion structure of the connection box and form a bolt tab 128 on the inside of the packing flange 125 of the protection pipe 120.

Here, one end of the ground wire 140 may be wound and fixed around the aluminum sheath of the power cable 110 at one or two positions by a wire 142, and soldering 143 may be performed at a plurality of positions for firm fixation.

Also, the ground wire 140 may be further fixed to the aluminum sheath of the power cable 110 by a band 160.

A fastening bolt 141 may be inserted or hooked to the other end of the ground wire 140, and then the fastening bolt 141 may be bolted to the bolt tab 128 of the packing flange 125, thereby implementing electrical connection between the protection pipe 120 and the power cable 110.

Since the ground wire connection structure of the protection pipe 120 may be realized by bolt connection, a process for implementing the ground wire connection structure is simpler than the conventional ground connection structure, and the electrical connection may be firmly improved.

Features, structures, and effects described in the above embodiments are incorporated into one embodiment of the present disclosure, but are not limited to only one embodiment. Moreover, features, structures, and effects exemplified in one embodiment may easily be combined and modified for another embodiment by those skilled in the art. Therefore, these combinations and modifications should be construed as falling within the scope of the present disclosure.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

[Description of reference numerals]

110: Power cable
120: Protection pipe
121: Cylindrical pipe
122: Flange
123: Protection layer
124: Ground terminal
125: Packing flange
126: First inclined surface
127: Bolt tab
128: Bolt tab
130: Rubber packing supporter
131a: Third inclined surface
131b: Fourth inclined surface
140: Ground wire
141: Bolt
142: Wire
143: Soldering
150: Support flange
151: Packing cylindrical pipe
152: Fastening flange
153: Second inclined surface
160: Band
170: Heat shrinkable tube

1. Aground structure of a power cable connection box, which connects a pair of power cables to each other and comprises a pair of protection pipes that protect the inside of a connection area and are connected to the pair of power cables, respectively, the ground structure comprising:
a flange integrated with one end of the protection pipe so as to be fastened to a connection component of the connection box;
a packing flange disposed between the flange and the other end of the protection pipe to face downwardly from an inner surface of the protection pipe;
a support flange comprising a fastening flange fastened to the other end of the protection pipe and a packing cylindrical pipe;
at least one bolt tab disposed inside the packing flange; and
a ground wire having one end, which is fastened to a metal sheath of each of the pair of power cables by a wire and soldered, and the other end, which is connected to a bolt and fastened to the bolt tab.

2. The ground structure of claim 1, further comprising a rubber packing supporter disposed in a space defined by the packing flange and the fastening flange to implement an anti-corrosion structure through fastening between the packing flange and the fastening flange.

3. The ground structure of claim 1, wherein the fastening flange has an outer diameter less than an inner diameter of the protection pipe, and
the rubber packing supporter has an outer diameter less than the inner diameter of the protection pipe.

4. The ground structure of claim 1, wherein the protection pipe, the support flange, and the rubber packing supporter are coupled to perform a cleat function that holds the power cable to prevent the power cable from being pushed.

5. The ground structure of claim 1, wherein one end of the ground wire is further fixed to the metal sheath of the power cable by a band.

6. Aground structure of a power cable connection box, which connects a pair of power cables to each other and comprises a pair of protection pipes that protect the inside of a connection area and are connected to the pair of power cables, respectively, the ground structure comprising:
a flange integrated with one end of the protection pipe so as to be fastened to a connection component of the connection box;
a packing flange disposed between the flange and the other end of the protection pipe to face downwardly from the inner surface;
a support flange comprising a fastening flange fastened to the other end of the protection pipe and a packing cylindrical pipe;
at least one bolt tab disposed inside the packing flange; and
a ground wire having one end, which is fastened to a metal sheath of each of the pair of power cables, and the other end, which is connected to a bolt and fastened to the bolt tab.

7. The ground structure of claim 6, further comprising a rubber packing supporter disposed in a space defined by the packing flange and the fastening flange to implement an anti-corrosion structure through fastening between the packing flange and the fastening flange,
wherein a first inclined surface is formed on one surface of the packing flange,
a second inclined surface, which is inclined in a direction opposite to the first inclined surface, is formed on one surface of the fastening flange,
the rubber packing supporter has a donut shape and a trapezoidal cross-section having a third inclined surface and a fourth inclined surface, and
the first inclined surface and the third inclined surface are brought into pressure contact with each other, and the second inclined surface and the fourth inclined surface are brought into pressure contact with each other.

8. The ground structure of claim 6, wherein one end of the ground wire is wound around the metal sheath of the power cable by a wire and connected thereto through soldering at a predetermined position.

9. The ground structure of claim 6, wherein one end of the ground wire is fixed and connected to the metal sheath of the power cable by a band.
